(19) United States
(12) Patent Application Publication
(10) Pub. No.: US 2021/0291553 A1
(43) Pub. Date: Sep. 23, 2021

(54) DETERMINING A PARAMETER OF NOZZLES ON A PRINT HEAD

(71) Applicant: Hewlett-Packard Development Company, L.P., Spring, TX (US)

(72) Inventors: Andreu Vinets Alonso, Sant Cugat del Valles (ES); Andrei Dafinoiu, Sant Cugat del Valles (ES); Antonio Gracia Verdugo, Sant Cugat del Valles (ES)

(73) Assignee: Hewlett-Packard Development Company, L.P., Spring, TX (US)

(21) Appl. No.: 17/259,570

(22) PCT Filed: Dec. 14, 2018
(86) PCT No.: PCT/US2018/065763

§ 371 Date: Jan. 12, 2021

(51) Int. Cl. B41J 2/21; B41J 2/145; B41J 29/393

(52) U.S. Cl. CPC B41J 2/2142; B41J 29/393; B41J 2/145

(57) ABSTRACT

In an example, a method comprises dispensing, sequentially from each of a plurality of nozzles of a print head, a respective drop of print agent to cause a print agent drop detection apparatus to output an associated signal, and determining that one of the nozzles is dispensing in a misdirected direction based on a comparison of the signals.

### BACKGROUND

A printing device may dispense drops of print agent onto a substrate to form images. The drops may be dispensed from nozzles on a print head of the printing device. In some circumstances, one or more nozzles may become blocked by dried print agent or may become damaged, for example due to contact between the print head and the substrate or due to cleaning (e.g. wiping) of the print head. These nozzles may thus no longer dispense print agent. In some circumstances, one or more nozzles may become misdirected. This may occur for example due to damage or partial blockage of a nozzle by dried print agent. A misdirected nozzle may dispense drops of print agent, but these drops may be dispensed in an unintended direction, which may lead to unintended artefacts in printed images.

### BRIEF DESCRIPTION OF DRAWINGS

Non-limiting examples will now be described with reference to the accompanying drawings, in which:

FIG. 1 is a flow chart of an example of a method, for example a method of determining misdirected nozzles on a print head;

FIG. 2 is a simplified schematic of an example illustrating a layout of nozzles on a print head;

FIG. 3 is a graph of an example of output signals from a detection apparatus detecting drops from nozzles on a print head;

FIG. 4 is a graph of an example of signals from the detection apparatus as a result of drops fired sequentially or individually from nozzles in a set of nozzles;

FIG. 5 is a graph of an example of signals from the detection apparatus as a result of drops fired sequentially or individually from nozzles in a set of nozzles;

FIG. 6 is a graph of an example of signals from the detection apparatus as a result of drops fired sequentially or individually from nozzles in a trench of nozzles;

FIG. 7 is a simplified schematic of an example of a printing device; and

FIG. 8 is a simplified schematic of an example of a misdirected nozzle detection apparatus.

### DETAILED DESCRIPTION

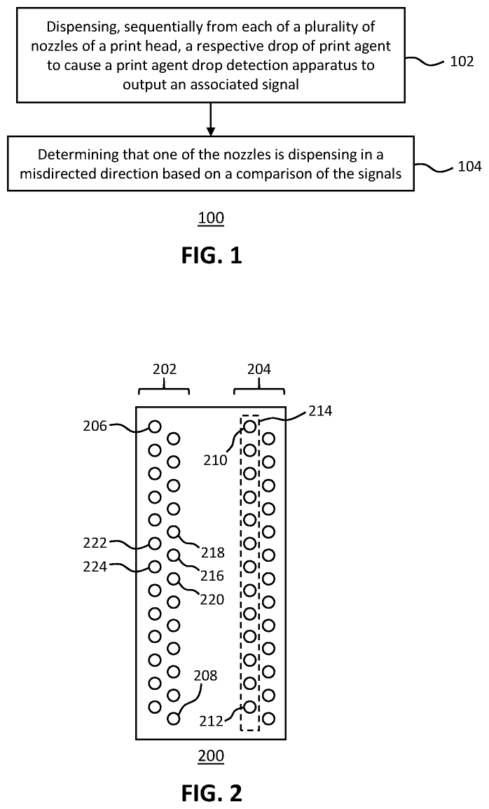

FIG. 1 is a flow chart of an example of a method 100. The method 100 may be for example a method of determining misdirected nozzles on a print head. The method 100 comprises, in block 102, dispensing, sequentially from each of a plurality of nozzles of a print head, a respective drop of print agent to cause a print agent drop detection apparatus to output an associated signal. That is, for example, the drops of print agent are dispensed from each nozzle such that up to one drop of print agent is within a detection zone of the detection apparatus at any time. A drop of print agent is within the detection zone for example when an output signal of the detection apparatus is caused or affected by the drop. In some examples, the detection apparatus may be a light source (e.g. light emitting diode, LED) and a photodetector. When a drop of print agent comes between the LED and the photodetector, the output signal of the detection apparatus is reduced, reflecting the reduced amount of light reaching the photodetector due to the presence of the drop.

Block 104 of the method 100 comprises determining that one of the nozzles is dispensing in a misdirected direction based on a comparison of the signals. For example, a signal caused by a drop from one nozzle that is significantly different to signals caused by a drop from one or more other nozzles may indicate that the nozzle is misdirected. This may in some examples contrast with a signal associated with a nozzle that is completely blocked or otherwise not dispensing drops, as for this nozzle there may be no measurable change in the output signal from the detection apparatus. On the other hand, a misdirected nozzle may still dispense a drop of print agent, which is detected by the print agent drop detection apparatus, but the nature of the signal may in some examples be analysed relative to signals associated with other nozzles to determine that the nozzle is misdirected.

In some examples, the signal from a nozzle is compared to signals from nearby or adjacent nozzles on the print head. This may be because there is deviation in the output signal from the detection apparatus depending on the location of the nozzle on the print head. In some examples, the print head is moved, for example during a nozzle test procedure, to a position in which it may fire drops that are detected by the detection apparatus. In some examples, the detection apparatus may be located in a fixed position, for example within a printing apparatus. Therefore, in some examples, the position of the nozzle on the print head dispensing a drop towards the detection apparatus may cause the signal from the detection apparatus to vary depending on which nozzle dispensed the drop.

FIG. 2 is a simplified schematic of an example illustrating a layout of nozzles on a print head 200. The print head 200 includes a first set of nozzles, generally indicated as 202, and a second set of nozzles, generally indicated as 204. In other examples, the print head 200 may include any number of one or more sets of nozzles. Each set of nozzles may be associated with one colour of print agent. For example, the first set of nozzles 202 may dispense a first colour of print agent, such as black, and the second set of nozzles 204 may dispense a second colour of print agent, such as cyan.

The physical location of nozzles on the print head may determine the physical position of a dispensed print agent drop, and hence may affect the output signal from the drop detection apparatus. For example, in the first set of nozzles 202, a nozzle 206 located at one end of the set of nozzles 202 may dispense a drop that results in a different signal from a nozzle 208 located at the other end. Furthermore, a drop dispensed from another set of nozzles, for example the nozzle 210 or 212 dispensed from the second set of nozzles 204, may also result in a different signal. In some examples, the nozzles in a set of nozzles on a print head may be arranged in columns or trenches of nozzles. FIG. 2 shows an example of a trench of nozzles 214 in the second set of nozzles 204. In the first set of nozzles 202, an example nozzle 216 may be adjacent to nozzles 218 and 220 in the same trench, and also adjacent to nozzles 222 and 224 in the set of nozzles (e.g. not in the same trench). In some examples, a print head may include one, two or more sets of nozzles, and/or the print head may include multiple arrangements of a print head 200 as shown in FIG. 2.

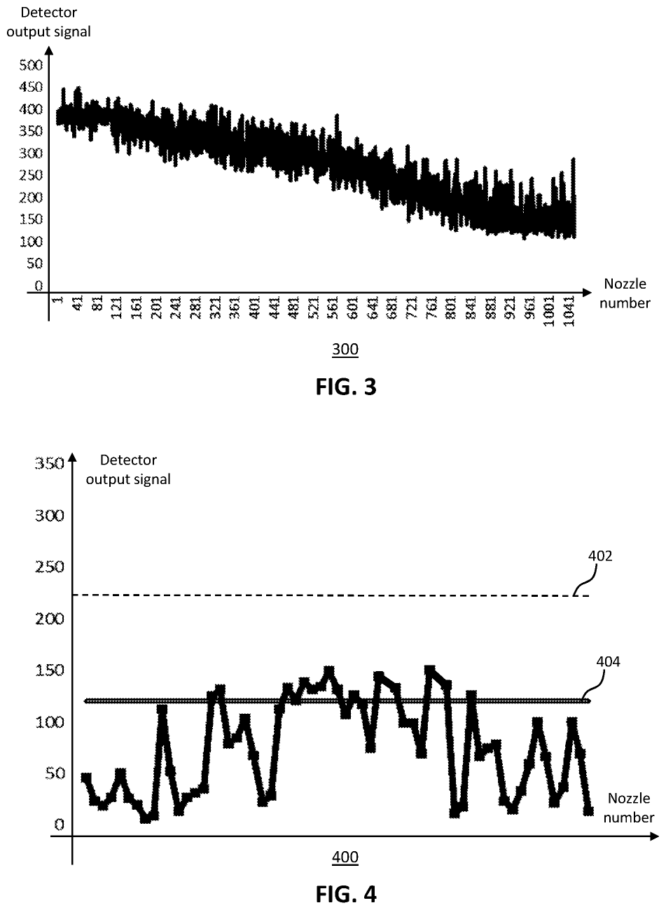

FIG. 3 is a graph 300 of an example of output signals from a detection apparatus detecting drops from nozzles on a print head. The x-axis shows nozzle number, and the y-axis shows a detector output signal. In this example, all of the nozzles are dispensing in intended directions, and none are misdirected. In some examples, such as for example in the graph 300 shown in FIG. 3, the output signal associated with a nozzle comprises a minimum of an output of the detection apparatus during detection of a drop dispensed from the nozzle. It can be seen in FIG. 3 that the signal varies significantly depending on nozzle number. Hence, the signal due to a drop from a misdirected nozzle may appear similar to the signal due to a drop from another nozzle that is dispensing in an intended direction, that may be located elsewhere on the print head. Hence, in some examples, the signals due to drops from adjacent or nearby nozzles may be compared to a signal from a particular nozzle to determine whether that nozzle is misdirected.

In some examples, determining that one of the nozzles is dispensing in a misdirected direction based on a comparison of the signals comprises determining a reference value from the signals, and determining that a portion of the signal associated with one of the nozzles differs from the reference value by a threshold amount. The reference value in some examples may be determined from signals associated with “nearby” nozzles, such as for example nozzles within a predetermined distance of the each other, nozzles in a single trench, nozzles in a set of nozzles on a print head, or any other group of nozzles. In some examples, the reference value may be an average or other summary or digest of the signals. In some examples, the portion of the signals comprises a minimum or other property of the signals. Thus, for example, if the signal associated with a particular nozzle differs from the average of signals associated with nearby signals by a threshold amount or more, the nozzle may be identified as misdirected.

In some examples, the plurality of nozzles comprise a first group of nozzles of the print head, and the print head includes a second group of nozzles. The groups of nozzles may in some examples be from the same set of nozzles, may be associated with the same colour print agent, may be trenches of nozzles, and/or may be adjacent nozzles. In a particular example, the first group of nozzles may be a set of nozzles, and the second group of nozzles may be a trench of nozzles in the set of nozzles. Thus in some examples one or more nozzles may be included in both groups. Dispensing a respective drop of print agent sequentially from the plurality of nozzles may in some examples comprise dispensing a respective drop of print agent sequentially from nozzles in the first and second groups of nozzles. The method may further comprise determining a further reference value from signals output from the print agent drop detection apparatus that are associated with nozzles in the second group of nozzles. The further reference value may be for example an average or other digest or value determined based on the signals. Determining that one of the nozzles is dispensing in a misdirected direction based on a comparison of the signals may comprise determining that the portion of the signal associated with one of the nozzles differs from the reference value by the threshold amount and a further portion of the signal associated with one of the nozzles differs from the further reference value by a further threshold amount. That is, for example, a nozzle is identified as misdirected if the signal associated with that nozzle differs significantly from both reference values that are based on signals associated with nozzles in first and second groups. This may in some examples help to avoid incorrectly concluding that a nozzle may be misdirected.

FIG. 4 is a graph 400 of an example of signals from the detection apparatus as a result of drops fired sequentially or individually from nozzles in a set of nozzles, such as for example the set 202 or the set 204 shown in FIG. 2. The signals may in some examples comprise a portion of signals from the graph 300 of FIG. 3, for example from a subset of nozzles that provided the results shown in FIG. 3. It can be seen that none of the points of the graph 400 provide a detector output signal that is higher than a threshold amount 402. In some examples, the threshold amount 402 may be an absolute threshold amount, a predetermined amount higher than a reference value 404 (e.g. average of the graph 400), or a predetermined proportion higher than the reference value 404. In some examples, as the detector output for all of these nozzles is lower than the threshold amount 508, the nozzles are determined to be operating correctly (e.g. they are not misdirected).

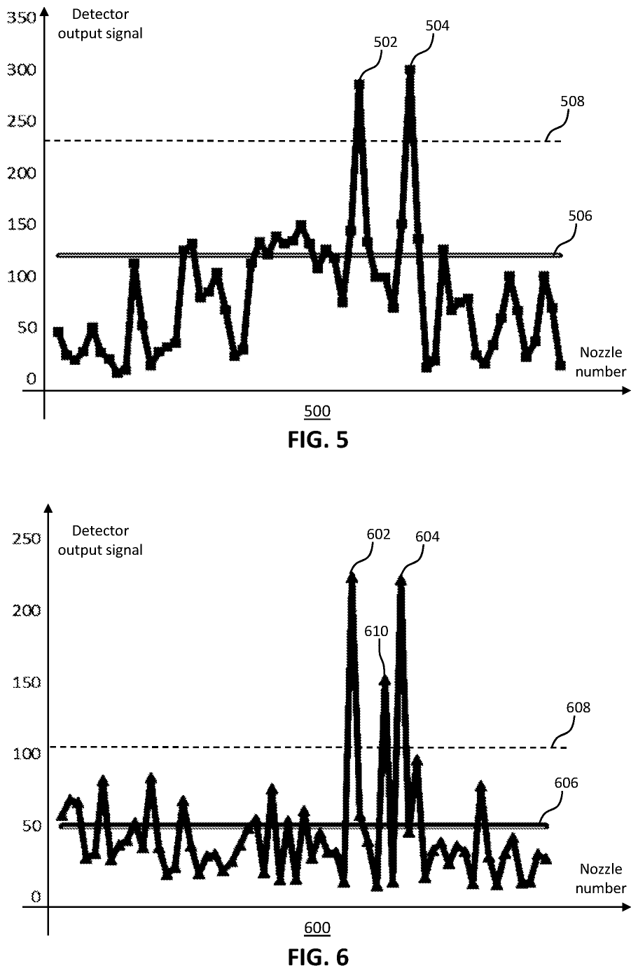

FIG. 5 is a graph 500 of an example of signals from the detection apparatus as a result of drops fired sequentially or individually from nozzles in a set of nozzles, such as for example the set 202 or the set 204 shown in FIG. 2. It can be seen that two nozzles may be misdirected, shown by points 502 and 504, which appear significantly higher than the other points. For example, the points 502 and 404 may be higher than a reference value 506 (e.g. average of the graph 500) by a threshold amount or greater. For example, the points 502 and 504 may be higher than a threshold amount 508. In some examples, the threshold amount 508 may be an absolute threshold amount, a predetermined amount higher than a reference value 506 (e.g. average of the graph 500), or a predetermined proportion higher than the reference value 506.

FIG. 6 is a graph 600 of an example of signals from the detection apparatus as a result of drops fired sequentially or individually from nozzles in a trench of nozzles. The trench of nozzles may be included in the set of nozzles that resulted in the graph 500 of FIG. 5. Two points 602 and 604 are associated with the same nozzles as the points 502 and 504 shown in FIG. 5. The points 602 and 604 are greater than a further reference value 606 (e.g. a value based on the graph 600) by a further threshold amount. For example, the points 602 and 604 may be greater than a further threshold amount 608, which may be for example an absolute threshold amount, a predetermined amount higher than a reference value 606 (e.g. average of the graph 600), or a predetermined proportion higher than the reference value 606. Thus, for example, as the two nozzles associated with points 502 and 504 in FIG. 5 and points 602 and 604 in FIG. 6 are greater than the respective threshold values by respective amounts, these two nozzles may be identified as misdirected. FIG. 6 shows a further point 610 that may be greater than the reference value 606 by the further threshold amount (e.g. may be highern than threshold amount 608). However, as the corresponding point in the graph 500 of FIG. 4 is not greater than the reference value 506 by the threshold amount (e.g. it is lower than the threshold amount 508), the associated nozzle is not identified as misdirected.

In some examples, the method 100 comprises forming images on a substrate including causing drops dispensable from the one of the nozzles that is dispensing in a misdirected direction to form the images to be dispensed by another nozzle. For example, if a nozzle is identified as misdirected, there may be opportunities to dispense the drop of the same colour from a different nozzle during a printing process such that the drop is applied in the same position as if it were applied by the misdirected nozzle dispensing normally. In some examples, a multi-pass printing process may be used in which the print head moves over the same region of a substrate multiple times, with the substrate advanced each time. There may thus be opportunities to print the same drop in a different pass when a different nozzle is in the correct position. Additionally or alternatively, a print head may include a mirror print head, which comprises a duplicate set of nozzles for redundancy. One of the duplicate nozzles may be used in place of the misdirected nozzle.

In some examples, determining that one of the nozzles is dispensing in a misdirected direction based on a comparison of the signals comprises determining that one of the nozzles is dispensing in a misdirected direction based on a comparison of a minimum of each of the signals.

In some examples, causing the print head to move to a position such that dispensing a respective drop of print agent from one of the nozzles causes the print agent drop detection apparatus to output the associated signal. For example, the print head may be moved to a predetermined position during a nozzle test procedure such that dispensed drops may be detected by the detection apparatus.

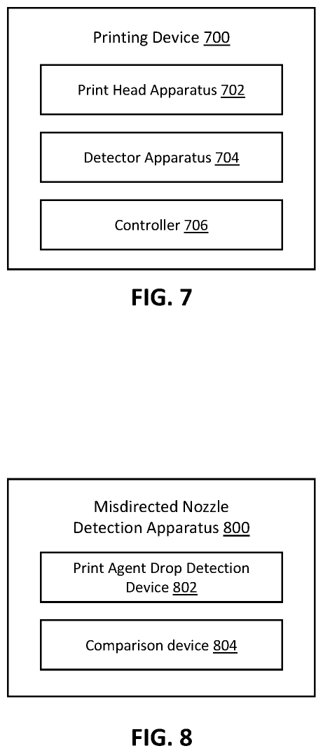

FIG. 7 is a simplified schematic of an example of a printing device 700. The printing device 700 comprises print head apparatus 702, detector apparatus 704 and a controller 706. The controller 706 is to cause the print head apparatus 704 to emit respective print agent drops towards the detector apparatus individually from a plurality of nozzles of the print head apparatus and to compare respective signals from the detector apparatus in response to the print agent drops to identify a misdirected nozzle of the plurality of nozzles. In some examples, the printing device 700 (e.g. the controller 706) may carry out the method 100 as described above with reference to FIG. 1.

In some examples, the plurality of nozzles comprise nozzles in a same trench of nozzles, and the controller 706 is to cause the print head 702 to emit respective print agent drops towards the detector apparatus individually from a second plurality of nozzles and to compare respective second signals from the detector apparatus in response to the print agent drops to identify the misdirected nozzle of the plurality of nozzles, wherein the second plurality of nozzles comprise adjacent nozzles on the print head. Thus, for example, the controller 706 may determine that a nozzle being considered differs from two groups of “nearby” or “neighbour” nozzles by a significant margin, and hence may identify the nozzle as being misdirected.

In some examples, the controller 706 is to compare respective signals from the detector apparatus in response to the print agent drops to identify a misdirected nozzle of the plurality of nozzles by calculating a reference value from the respective signals and comparing each respective signal to the reference value. The reference value may be for example an average value or any other value that represents signals resulting from drops emitted individually or sequentially by a group of nozzles (e.g. in a set or trench).

In some examples, the controller 706 is to determine the respective signals from the detector apparatus by determining, for each print agent drop, a respective lowest value (e.g. minimum) of an output of the detector apparatus, for example during detection of a drop from one of the nozzles.

FIG. 8 is a simplified schematic of an example of a misdirected nozzle detection apparatus 800. The apparatus 800 comprises a print agent drop detection device 802 to provide a first signal in response to a first drop of print agent dispensed from a first nozzle of a print head of a printing apparatus and to provide a second signal in response to a second drop of print agent dispensed from a second nozzle of the print head of the printing apparatus. The apparatus 800 also comprises a comparison device to identify the first or second nozzle as a misdirected nozzle by comparing the first and second signals. In some examples, the apparatus 800 may be included within a printing device or apparatus, such as for example the printing device 700 of FIG. 7.

The first and second nozzles may in some examples comprise adjacent nozzles of the print head, such as for example adjacent nozzles within a set of nozzles. The print agent drop detection device 802 may for example provide a third signal in response to a third drop of print agent dispensed from a third nozzle of a print head of the printing apparatus. The first and third nozzles may comprise nozzles in a trench of nozzles of the print head, and the comparison device may identify the first nozzle as a misdirected nozzle by comparing the first and second signals and by comparing the first and third signals. This may help to avoid incorrectly identifying nozzles as misdirected or misdirected, for example by ensuring that a signal from a nozzle indicates that the nozzle is misdirected when the signal is compared to signals associated with nozzles of two different groups of nozzles (though in some examples some nozzles may be in both groups).

In some examples, the apparatus 800 is to cause a printing apparatus to apply images to media using the print head without using the first or second nozzle that is identified as a misdirected nozzle. In such cases, for example, a different nozzle may be used, for example a different nozzle in the same set or trench in a multi-pass printing process, or a nozzle in a different set (e.g. where there are mirrored print heads).

In some examples, the apparatus 800 is to cause the print head to move to a predetermined position such that the print agent drop detection device 802 is to provide the first and second signals. This may occur for example in a nozzle test process before drops are dispensed from the nozzles and detected by the detection device 802.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
dispensing, sequentially from each of a plurality of nozzles of a print head, a respective drop of print agent to cause a print agent drop detection apparatus to output an associated signal; and
determining that one of the nozzles is dispensing in a misdirected direction based on a comparison of the signals.

2. The method of claim 1, wherein determining that one of the nozzles is dispensing in a misdirected direction based on a comparison of the signals comprises determining a reference value from the signals, and determining that a portion of the signal associated with one of the nozzles differs from the reference value by a threshold amount.

3. The method of claim 2, wherein the plurality of nozzles comprise a first group of nozzles of the print head, the print head includes a second group of nozzles, dispensing a respective drop of print agent sequentially from the plurality of nozzles comprises dispensing a respective drop of print agent sequentially from nozzles in the first and second groups of nozzles, and the method further comprises:
determining a further reference value from signals output from the print agent drop detection apparatus that are associated with nozzles in the second group of nozzles; and
and wherein determining that one of the nozzles is dispensing in a misdirected direction based on a comparison of the signals comprises determining that the portion of the signal associated with one of the nozzles differs from the reference value by the threshold amount and a further portion of the signal associated with one of the nozzles differs from the further reference value by a further threshold amount.

4. The method of claim 3, wherein the first group of nozzles comprises nozzles on the print head that are adjacent, and the second group of nozzles comprises nozzles in a trench of nozzles on the print head.

5. The method of claim 1, comprising forming images on a substrate including causing drops dispensable from the one of the nozzles that is dispensing in a misdirected direction to form the images to be dispensed by another nozzle.

6. The method of claim 1, wherein determining that one of the nozzles is dispensing in a misdirected direction based on a comparison of the signals comprises determining that one of the nozzles is dispensing in a misdirected direction based on a comparison of a minimum of each of the signals.

7. The method of claim 1, comprising causing the print head to move to a position such that dispensing a respective drop of print agent from one of the nozzles causes the print agent drop detection apparatus to output the associated signal.

8. A printing device comprising:
print head apparatus;
detector apparatus; and
a controller to cause the print head apparatus to emit respective print agent drops towards the detector apparatus individually from a plurality of nozzles of the print head apparatus and to compare respective signals from the detector apparatus in response to the print agent drops to identify a misdirected nozzle of the plurality of nozzles.

9. The apparatus of claim 8, wherein the plurality of nozzles comprise nozzles in a same trench of nozzles, and the controller is to cause the print head apparatus to emit respective print agent drops towards the detector apparatus individually from a second plurality of nozzles and to compare respective second signals from the detector apparatus in response to the print agent drops to identify the misdirected nozzle of the plurality of nozzles, wherein the second plurality of nozzles comprise adjacent nozzles on the print head apparatus.

10. The apparatus of claim 8, wherein the controller is to compare respective signals from the detector apparatus in response to the print agent drops to identify a misdirected nozzle of the plurality of nozzles by calculating a reference value from the respective signals and comparing each respective signal to the reference value.

11. The apparatus of claim 8, wherein the controller is to determine the respective signals from the detector apparatus by determining, for each print agent drop, a respective lowest value of an output of the detector apparatus.

12. A misdirected nozzle detection apparatus comprising:
a print agent drop detection device to provide a first signal in response to a first drop of print agent dispensed from a first nozzle of a print head of a printing apparatus and to provide a second signal in response to a second drop of print agent dispensed from a second nozzle of the print head of the printing apparatus; and
a comparison device to identify the first or second nozzle as a misdirected nozzle by comparing the first and second signals.

13. The apparatus of claim 12, wherein the first and second nozzles comprise adjacent nozzles of the print head, and the print agent drop detection device to provide a third signal in response to a third drop of print agent dispensed from a third nozzle of a print head of the printing apparatus, wherein the first and third nozzles comprise nozzles in a trench of nozzles of the print head, and the comparison device to identify the first nozzle as a misdirected nozzle by comparing the first and second signals and by comparing the first and third signals.

14. The apparatus of claim 12, wherein the apparatus is to cause a printing apparatus to apply images to media using the print head without using the first or second nozzle that is identified as a misdirected nozzle.

15. The apparatus of claim 12, wherein the apparatus is to cause the print head to move to a predetermined position such that the print agent drop detection device is to provide the first and second signals.
